(19) United States
(12) Patent Application Publication
(10) Pub. No.: US 2011/0227745 A1
(43) Pub. Date: Sep. 22, 2011

(54) OPERATIONAL MANAGEMENT SYSTEM OF AGRICULTURAL WORK VEHICLE

(75) Inventors: Kenji KIKUCHI, Tokyo (JP); Atsuhiro SAEGUSA, Tokyo (JP); Noriko YAMAGATA, Tokyo (JP)

(73) Assignee: HITACHI SOLUTIONS, LTD., Tokyo (JP)

(21) Appl. No.: 13/030,412

(22) Filed: Feb. 18, 2011

(30) Foreign Application Priority Data
Mar. 19, 2010 (JP) 2010-064455

(51) Int. Cl. G08B 21/00

(52) U.S. Cl. 340/684

(57) ABSTRACT

Positional information transmitted from a mobile unit mounted on an agricultural work vehicle is displayed overlapping with map data obtained from a map database. Display of the field data on the display screen is color-coded based on a result of comparison of a date of the positional information transmitted from the mobile unit with the field data obtained from the map database and a scheduled date for work stored in the field data. Thereby, an operational management system of an agricultural work vehicle capable of promptly and spatially confirming an operational situation of the agricultural work vehicle is provided.

### BACKGROUND OF THE INVENTION

1. Field of the Invention

The present invention relates to an operational management system of an agricultural work vehicle for managing an operational situation such as a movement locus of an agricultural work vehicle including a combine harvester, and displaying the situation on a mapping system.

2. Background Art

In recent years, IT (Information Technology) has been actively introduced into the agricultural industry, and field management or the like using a mapping system has been performed.

Additionally, in order to efficiently perform agricultural work, it is essential to use an agricultural work vehicle such as a combine harvester or a tractor. As a technology for supporting operation of these agricultural work vehicles, proposed is the one which provides a position of the vehicle in a field or information on supporting the operation such as a running/work locus, or the one which supports unattendant operation of the work vehicle, when the vehicle moves and works. Publicly-known technical documents related to the present invention have Patent Document 1 (JP Patent Publication (Kokai) No. 10-188786 A (1998)) and Patent Document 2 (JP Patent Publication (Kokai) No. 10-66406 A (1998)).

### SUMMARY OF THE INVENTION

Regarding a large-size agricultural work vehicle such as a combine harvester or a tractor, the plurality of vehicles are generally operated and managed by a regional agricultural association or the like. In such case of operating the plurality of agricultural work vehicles, it is required to perform operation for efficient work as a whole, such as adequate placement of the work vehicles, in addition to streamlining of the work in a field. This requires to draw up an adequate work plan and to modify the plan depending on situations. It is necessary to correctly and promptly comprehend operational and work situations.

However, in the current situation, it is often the case that the understanding of the situations is made by a work report such as a verbal report by a worker. This leads to the difficulty in correctly comprehending a region where the work is performed.

It sometimes wastes time from termination of the work till the reporting. Accordingly, it is difficult to take rapid countermeasures depending on situations.

The above-mentioned Patent Documents 1 and 2 and the like are allowed to streamline the work in the field. However, the art described in the documents cannot solve these problems.

An object of the present invention is to provide an operational management system of an agricultural work vehicle capable of promptly and spatially confirming an operational situation of the agricultural work vehicle.

In order to solve the above-mentioned object, an operational management system of an agricultural work vehicle according to the present invention includes a mechanism configured to receive positional information transmitted from a mobile unit mounted on an agricultural work vehicle and display on a display screen the positional information overlapping with map data obtained from a map database.

Additionally, the operational management system of an agricultural work vehicle according to the present invention further includes a mechanism configured to, depending on conditions in which the positional information transmitted from the mobile unit is overlapped with field data obtained from the map database, execute color-coded display of a work situation on the display screen.

Moreover, the operational management system of an agricultural work vehicle according to the present invention includes a mechanism configured to, based on a result from comparison of a date of the positional information transmitted from the mobile unit with the field data obtained from the map database and a scheduled date for work stored in the field data, execute the color-coded display of the field data on the display screen.

According to the present invention, the following effect can be exerted: it is possible to promptly display, as a work locus, a situation of agricultural work by use of an agricultural work vehicle on a map and spatially confirm the situation of the agricultural work with ease.

### BRIEF DESCRIPTION OF THE DRAWINGS

FIG. 1 is a diagram showing one embodiment of a system according to the present invention.

FIG. 2 is a diagram showing a data structure of field data.

FIG. 3 is a diagram showing a data structure of work data.

FIG. 4 is a flowchart showing positional-information measurement processing.

FIG. 5 is a flowchart showing work-situation determination processing.

FIG. 6 is a diagram showing a display example of a result from the work-situation determination processing.

FIG. 7 is a diagram showing a display example of a work situation.

### DETAILED DESCRIPTION OF THE PREFERRED EMBODIMENT

Hereinafter, a specific description will be made with reference to the figures showing one embodiment when the present invention is performed.

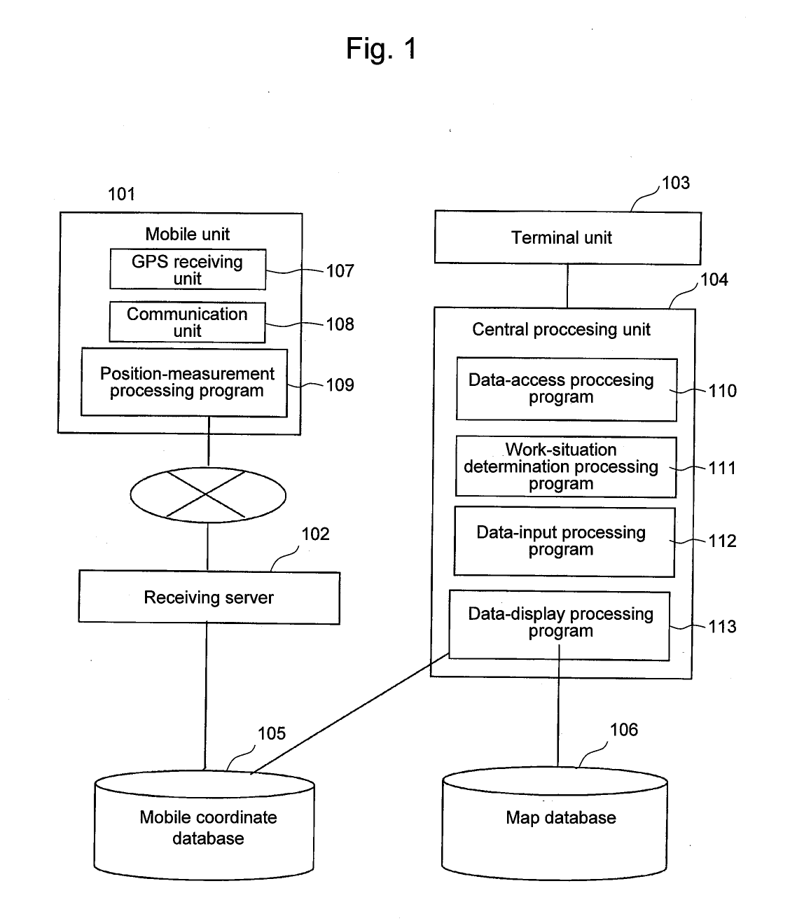

FIG. 1 is a diagram showing one embodiment of an operational support system according to the present invention.

As shown in FIG. 1, this operation supporting system is configured of a mobile unit 101 which obtains positional information from GPS and transmits the information to a receiving server 102 using a wireless line such as a mobile phone or a wireless LAN, the receiving server 102 which receives the positional information transmitted from the mobile unit 101 and stores the information therein, a terminal unit 103 which has characters and a graphic screen, a central processing unit 104, a mobile coordinate database 105 which stores therein coordinate data on the mobile unit 101, and a map database 106 which has stored therein map data as background data.

The mobile unit 101 has a GPS receiving unit 107, a communication unit 108, and a position-measurement processing program 109.

The GPS receiving unit 107 is a unit which obtains the positional information from GPS. The communication unit 108 is a unit which transmits to the receiving server 102 the positional information obtained by the GPS receiving unit 107.

The position-measurement processing program 109 is a program which controls the GPS receiving unit 107 and the communication unit 108; measures a position; and transmits the positional information.

The central processing unit 104 has a data-access processing program 110, a work-situation determination processing program 111, a data-input processing program 112, and a data-display processing program 113. The data-access processing program 110 executes reference or updates etc. to a mobile coordinate database 105 and the map database 106, if needed.

The work-situation determination processing program 111 determines a work situation based on the mobile coordinate data and the map data.

The data-input processing program 112 receives data input through the terminal unit 103. The data-display processing program 113 displays, on a display screen of the terminal unit 103, field data or work data on the map data which will be a background.

The data stored in the respective databases will be described here.

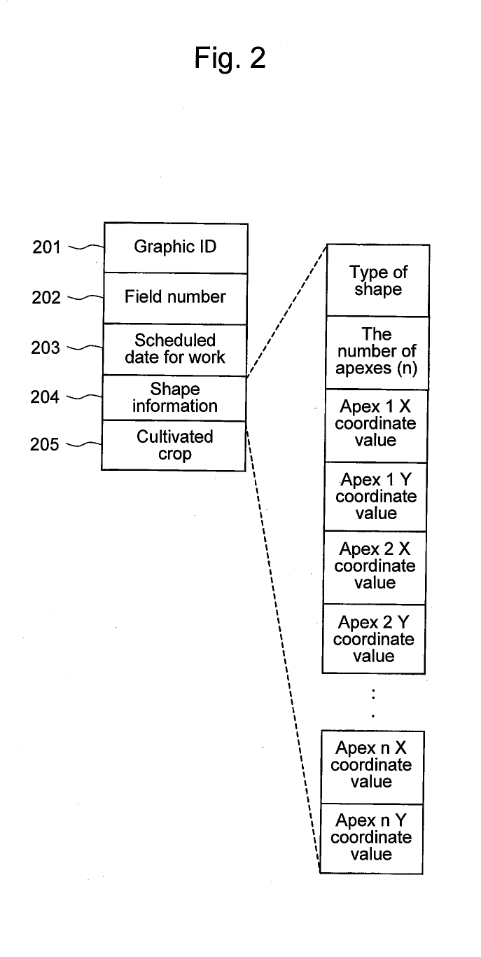

FIG. 2 is a diagram showing a data structure of the field data.

The field data has a graphic ID 201 for specifying a graphic, or a field number 202 for specifying a field. In addition, the field data has a scheduled date for work 203 which is a scheduled date for performing the work, or shape information 204 which retains geographical information such as the position of the graphic or the shape. Further, the field data has information on a cultivated crop 205 or the like, which is information on a cultivated crop.

This field data has been stored in the map database 106.

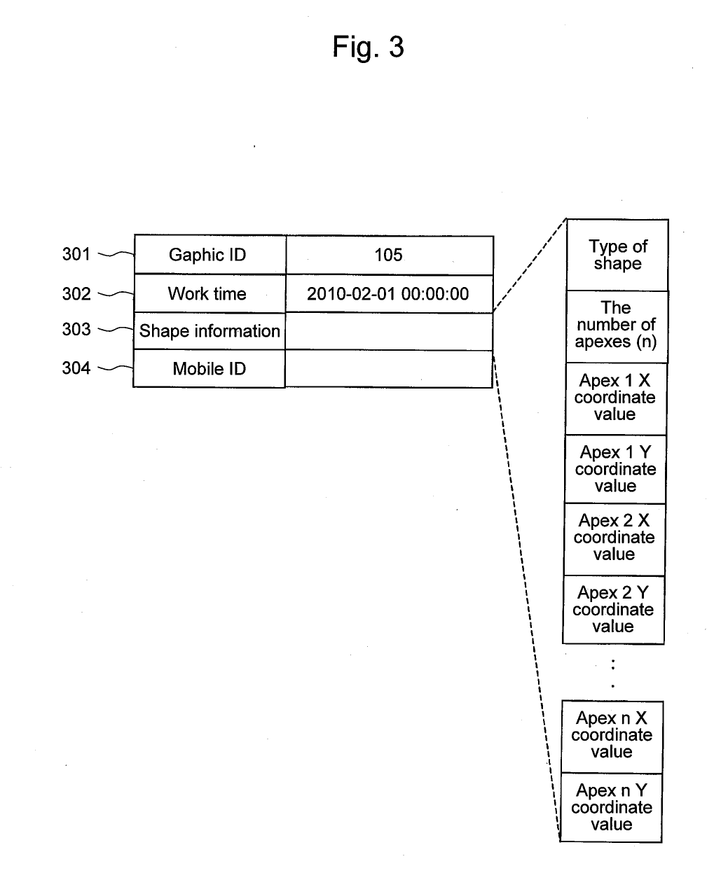

FIG. 3 is a diagram showing the data structure of the work data.

The work data has a graphic ID 301 for specifying the graphic, a work time 302 which records the last time when a series of the works has been performed, and shape information 303 which retains a region where the work has been performed.

Next, position measurement processing will be explained.

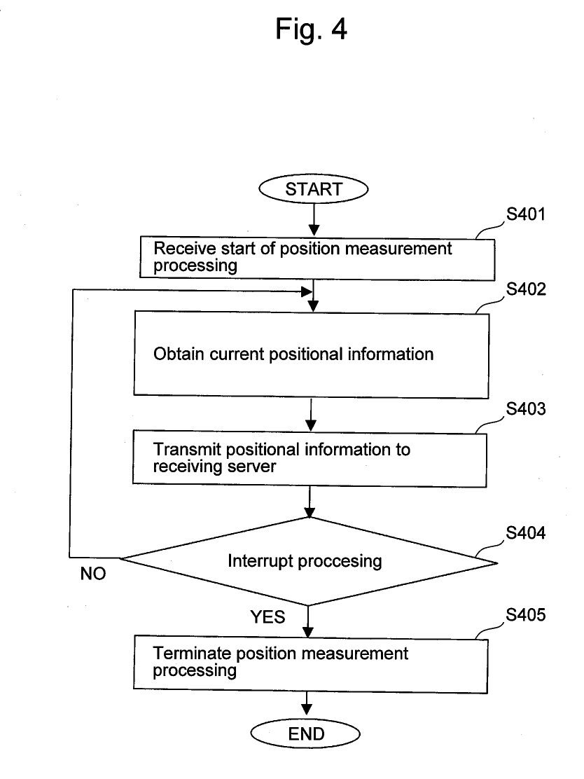

FIG. 4 is a flowchart showing the position measurement processing in the mobile unit 101.

Firstly, in Step S401, the mobile unit 101 receives a start of the position measurement processing.

In Step S402, the mobile unit 101 receives the current positional information by use of the GPS receiving unit 107.

Then, in Step S403, the mobile unit 101 transmits the positional information obtained by the GPS receiving unit 107 to the receiving server 102. The server 102 having received the positional information stores the received data, in other words, the positional information on the mobile in the mobile coordinate database 105 in chronological order.

Thereafter, in Step S404, the mobile unit 101 determines whether or not an interruption of the processing has been received. When having received the interruption, the mobile unit 101 terminates the processing in Step S405. Meanwhile, when having not received the interruption, the mobile unit 101 returns the processing to Step S402, and continues the processing.

Next, work-situation determination processing will be explained.

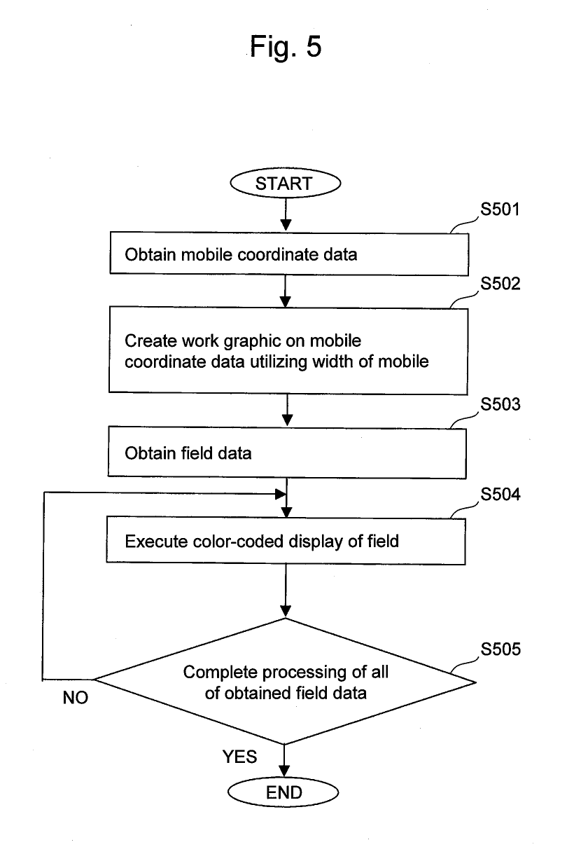

FIG. 5 is a flowchart showing the work-situation determination processing in the central processing unit 104.

Firstly, in Step S501, the central processing unit 104 obtains the mobile coordinate data from the mobile coordinate database 105.

Next, in Step S502, the central processing unit 104 creates a work graphic utilizing the obtained mobile coordinate data and a given width of the mobile.

In Step S503, the central processing unit 104 obtains the field data from the map database 106.

In Step S504, the central processing unit 104 executes color-coded display of the field displayed on the display screen of the terminal unit 103, depending on specified conditions.

Here, the conditions to be specified include, for example: a color code of the field where the work has been performed and the one where the work has not been performed; the display of, in a warning color, the field where the work has not been performed even after the scheduled date is overdue; or the color-coded display of a percentage of an area where the work graphic and the field are overlapped with each other.

In Step S505, the central processing unit 104 determines whether or not the processing of all of the obtained field data is completed. When the processing is completed, the central processing unit 104 terminates the processing. Meanwhile, when the processing is not completed, the color code of the field is executed in Step S504.

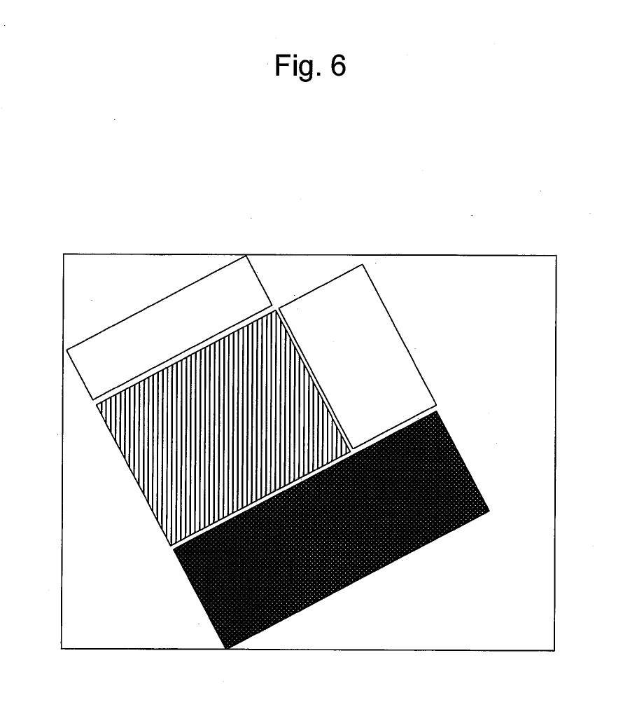

FIG. 6 is a display example of a result after the work-situation determination processing has been executed. In comparison of the scheduled date with the work date or the like, the color-code display of the field is executed, whereby it is easier to comprehend the work situation and to make a decision of operational management of a work vehicle.

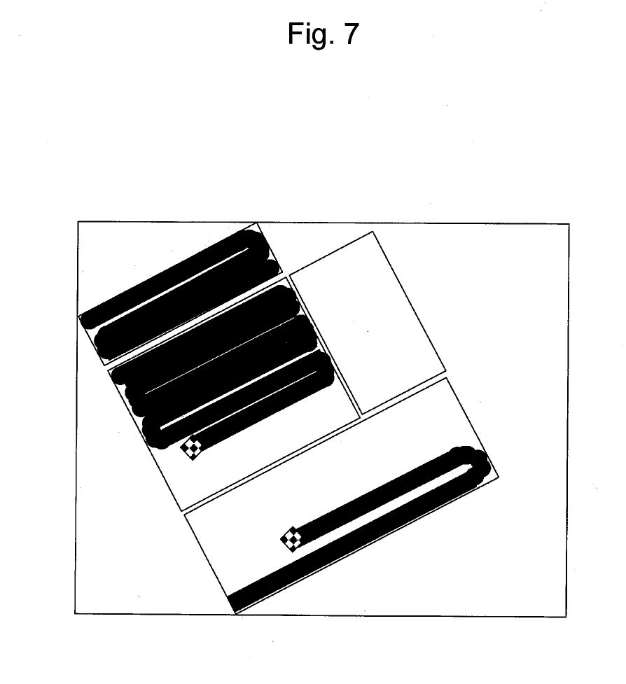

FIG. 7 is a display example of the work situation. This example displays the work data and the position of the work vehicle on a map with the both being overlapped with each other.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications within the ambit of the appended claims.

What is claimed is:

1. An operational management system of an agricultural work vehicle, comprising a mechanism configured to receive positional information transmitted from a mobile unit mounted on an agricultural work vehicle and display on a display screen the positional information overlapping with map data obtained from a map database.

2. The operational management system of an agricultural work vehicle according to claim 1, further comprising a mechanism configured to, depending on conditions in which the positional information transmitted from the mobile unit is overlapped with field data obtained from the map database, execute color-coded display of a work situation on the display screen.

3. The operational management system of an agricultural work vehicle according to claim 2, further comprising a mechanism configured to, based on a result from comparison of a date of the positional information transmitted from the mobile unit with the field data obtained from the map database and a scheduled date for work stored in the field data, execute the color-coded display of the field data on the display screen.
